(19) United States
(12) Patent Application Publication
(10) Pub. No.: US 2026/0341740 A1
(43) Pub. Date: Oct. 29, 2026

(54) CURRENT COLLECTOR FOR AN ELECTROCHEMICAL DEVICE FOR STORING OR GENERATING ELECTRICAL POWER

(71) Applicant: NAWAH, Rousset (FR)

(72) Inventors: Elodie VIEU, Rousset (FR); Léo NEGRE, Cabries (FR); Marc ZIMMERMANN, Trets (FR)

(21) Appl. No.: 19/099,035

(22) PCT Filed: Jul. 25, 2023
(86) PCT No.: PCT/IB2023/057526

§ 371 Date: Jan. 27, 2025

(30) Foreign Application Priority Data
Jul. 28, 2022 (FR) 2207767

(51) Int. Cl. H01M 4/66; H01M 4/02; H01M 4/82

(52) U.S. Cl. CPC H01M 4/668; H01M 4/663; H01M 4/667; H01M 4/82; H01M 2004/021

(57) ABSTRACT

The invention relates to a current collector for an electrical power storage system or electricity generation system comprising an electronically conductive substrate, an electrically non-conductive polymer matrix, and carbon nanotubes. These nanotubes comprise a first end attached to the surface of the electronically conductive substrate and electrically connected to the latter, as well as a second end, opposite the first end, capable of collecting the current from an electrode, so as to create on the surface of the electronically conductive substrate a layer comprising a plurality of collection regions, which are electrically insulated from one another by intermediate zones of the electrically non-conductive polymer matrix. Each collection region comprises a plurality of the carbon nanotubes, and the set of second ends of the carbon nanotubes in each collection region protrudes beyond the surface of the electrically non-conductive polymer matrix.

### TECHNICAL FIELD OF THE INVENTION

The present invention relates to the field of electrochemical devices, and more precisely to the field of electrochemical devices for the storage and generation of electrical energy.

It relates more specifically to current collectors usable in electrochemical systems and devices for generating electrical energy, such as fuel cells, and in electrochemical systems and devices for storing electrical energy, such as batteries (and more particularly lithium ion batteries and lithium-air batteries) and supercapacitors. These current collectors have a particular geometry which allows, when used in energy storage devices, to optimize the adhesion of the active material of the electrode to the current collector while limiting the interfacial resistance. The invention also relates to a method of manufacturing such a current collector, having a novel architecture, which gives it excellent electrical conductivity.

### STATE OF THE ART

The electrodes of energy storage devices, particularly electrochemical systems, are usually made by depositing an active material on thin electrically conductive films called Current current collectors. collectors allow electric current to flow to and/or from the active material, while providing mechanically robust support for the active material. The main current collectors used in these energy storage devices are sheets of aluminum, copper, stainless steel or nickel, with a thickness of less than 40 μm.

The electrodes of these energy storage devices are generally made up of active material particles, binders ensuring the mechanical cohesion of the electrode and conductive particles ensuring electrical conductivity within the electrode.

Sufficient adhesion of the active material to the current collector is desirable in order to ensure the processability of the electrode during the assembly steps of the electrochemical system, for example during cutting or winding steps. This adhesion is also desirable in order to optimize the lifespan of the energy storage device comprising it. Since the materials used to make the current collector are different from those present in the electrode, the binders must ensure both the cohesion of the active material but also the good adhesion of the latter to the current collector, which can constrain the choice. In addition, the proportion of binder in the active material must be adjusted to ensure sufficient adhesion to the current collector. In order to optimize the operation of the system, the electronic transfer between the current collector and the active material must be as efficient as possible. The contact between the current collector and the active material consisting of particles leads to the formation of an interfacial electrical resistance. This electrical resistance, which contributes to the series resistance of the device, is all the more important as the quantity of binder in the active material is important. There is therefore a compromise between the need to ensure adhesion of the active material to the current collector and the need to limit the interfacial resistance.

Increasing the proportion of binders and electrically conductive particles in the active material ensures both good adhesion and limits interfacial resistance. However, these elements do not contribute to the ability of the active material to store electrical energy, which is its primary purpose. It is desirable to maintain the highest possible active particle content in the active material in order to obtain the most efficient energy storage system possible, while reducing production and raw material costs.

Different types of current collectors have been developed that provide better performance to the electrical energy storage devices containing them. It is known from EP 2 500 969 A1 to use as a current collector, an aluminum sheet comprising between 0.01 and 3.0% by mass of dispersed and supported carbon particles in order to reduce the electrical interfacial resistance. From U.S. Pat. No. 8,785,053 B2, it is known to use a current collector comprising a support and a layer of uniformly distributed carbon nanotubes, arranged on this support, in order to give it high resistance to corrosion.

In order to limit corrosion or prevent oxidation of the current collector even when the operating potential of the electrical energy storage device is greater than or equal to the oxidation potential of the material forming the current collector, it is known from EP 3 716 378 A1 to coat the current collector of an electrical energy storage device with an interface layer. This interface layer comprises a binder and a conductive material such as carbon particles, particularly in the form of carbon black, graphite, graphene or even carbon nanotubes. Is is also known from US 2012/0121974 to protect the current collector of the cathode by a porous protective conductive coating comprising conductive carbon or graphite.

However, this interface layer still generates an electrical contact resistance both between the interface layer and the substrate, and between this interface layer and the active material. Furthermore, since the contact surface between the active material and the current collector is small, it is necessary to use a significant quantity of carbon particles in this interface layer.

An objective of the present invention is to remedy at least in part the drawbacks of the prior art mentioned above.

In particular, it aims to propose a current collector that can be used in any electrochemical energy storage system, effectively ensuring the adhesion of the active material while limiting interfacial resistance.

In particular, it aims to propose a process which makes it possible to manufacture in a simple, reliable and fast way a current collector with a very long lifespan.

It also aims to propose an energy storage device, preferably an electrochemical energy storage system such as a battery, a super-capacitor, or even a fuel cell, with a very long lifespan.

### OBJECTS OF THE INVENTION

At least one of the above objectives is achieved by means of at least one of the objects according to the invention, as presented below. present invention provides as respective objects a current collector, its manufacturing method as well as an energy storage device such as a battery, these objects being stated in the appended claims.

The present invention provides as a first object a current collector for an electrochemical energy storage system or electrochemical generation system comprising:
a. an electronically conductive substrate,
b. an electrically non-conductive polymer matrix, and
c. carbon nanotubes comprising
   a first end called the transfer end, for transferring the current to the substrate, this first end being fixed on the surface of said electronically conductive substrate and electrically connected to the surface of said electronically conductive substrate,
   as well as a second end, opposite said first end, called the collection end, capable of collecting the current from an external active material, in particular from an electrode,
so as to create on the surface of said electronically conductive substrate, a layer comprising a plurality of collection regions, which are electrically insulated from each other by intermediate zones of said electrically non-conductive polymer matrix, and where
   each collection region comprises a plurality of said carbon nanotubes, and
   all of the second ends of said carbon nanotubes of each collection region protrude beyond the surface of the electrically non-conductive polymer matrix.

According to other features of the current collector according to the invention, which can be taken separately individually or according to any technically compatible feature:
the carbon nanotubes of the collection regions have, in top view, an average intertube spacing of less than 100 nm,
said collection regions have, in top view, a circular shape, and the smallest distance between the outer edges of said collection regions is, in top view, greater than or equal to 1 μm, preferably greater than 10 μm,
said electronically conductive substrate is chosen from copper, aluminum, nickel, stainless steel, heavily doped silicon, carbon and composite materials comprising carbon and, preferably, from composite materials comprising carbon and a resin chosen from polyester, vinyl ester, epoxy, phenolic, polyimide, polyamide, polypropylene, polyetheretherketone resins or a mixture of one or more of these,
said electronically conductive substrate is chosen from planar substrates, substrates in the form of a grid, substrates in the form of fibers and substrates in the form of felt,
said carbon nanotubes, electrically connected to the surface of said electronically conductive substrate, have
   a thickness of less than 10 μm, preferably less than 1 μm and/or
   a developed surface area greater than 100 m²/g, preferably greater than 250 m²//g,
      the volume ratio of non-electrically conductive polymer matrix/carbon nanotubes is less than 300%, preferably less than 2008, and even more preferably less than 70%.

The invention also relates to a device for storing or generating electrical energy such as a battery, a supercapacitor or a fuel cell comprising a current collector according to the invention.

The invention also relates to an electrochemical system for storing or generating electrical energy comprising a current collector according to the invention.

The invention eventually relates to a method for manufacturing a current collector comprising an electronically conductive substrate, carbon nanotubes having one end fixed on the surface of said electronically conductive substrate, and a polymer matrix that is not electrically conductive, said method comprising the following successive steps:
a. synthesizing, on the electronically conductive substrate, vertically aligned carbon nanotubes so as to form a carpet, preferably by the chemical vapor deposition technique, or transferring aligned nanotubes synthesized on another substrate onto said electronically conductive substrate,
b. depositing, by any suitable means, preferably by liquid phase deposition process, said electrically non-conductive polymer matrix, on said carbon nanotubes, so as to create on the surface of said electronically conductive substrate, a layer comprising a plurality of collection regions, which are electrically insulated from each other by intercalary zones of said electrically non-conductive polymer matrix, and where
   each collection region comprises a plurality of said carbon nanotubes, and
   all of the second ends of said aligned carbon nanotubes of each collection region protrude beyond the surface of the electrically non-conductive polymer matrix.

Advantageously, the deposition of said electrically non-conductive polymer matrix, during step b) is carried out by a method chosen from coating, spraying, soak-removal, extrusion, single or multi-stage infiltration, and single or multi-stage infusion.

### FIGURES

The invention will be described below, with reference to the attached drawings, given solely as non-limiting examples. FIGS. 1 to 10 illustrate certain aspects of the invention. FIGS. 1 to 3 show, schematically, a current collector according to the invention.

FIG. 1 is a longitudinal sectional view, illustrating a current collector (1) according to the invention comprising an electronically conductive substrate (2), vertically aligned carbon nanotubes (3) forming collection regions (33) and an electrically non-conductive polymer matrix (4) forming intermediate zones (41) of electrically non-conductive polymer matrix.

FIG. 2 is a top view, similar to FIG. 1, illustrating a current collector (1) according to the invention, and more particularly, the circular shapes of the collection regions (33) each comprising a plurality of vertically aligned carbon nanotubes (3) as well as the smallest distance (d) between the outer edges of said collection regions.

FIG. 3 is a longitudinal sectional view, illustrating an electrode (10) of an energy storage system comprising a current collector (1) according to the invention and active material (5) arranged on this current collector.

FIG. 4 schematically represents a three-dimensional exploded perspective view of a standardized Swagelok™ type cell, allowing the evaluation of wet supercapacitor components, and showing a central separator, electrodes arranged at both ends of the central separator and current collectors arranged on the ends of the electrodes, on the side opposite the separator.

FIG. 5 schematically represents a three-dimensional exploded perspective view of a standardized Swagelok™ type cell, allowing the evaluation of supercapacitor components in the dry process, and showing a central separator, self-supporting electrodes arranged at both ends of the central separator and current collectors arranged on the ends of the self-supporting electrodes, on the side opposite the separator.

FIG. 6 schematically represents a three-dimensional exploded view of a standardized half-cell of the “coin cell 2032” type battery, allowing the components of a battery to be evaluated, and showing a central separator (Celgard 3501 impregnated with a 1M LiPF₆ electrolytic solution in a mixture of ethyl carbonate (EC) and diethyl carbonate (DEC) with an EC/DEC ratio (1:1)), electrodes arranged at both ends of the central separator and current collectors arranged on the ends of the electrodes, on the side opposite the separator.

FIG. 7 schematically represents an exploded three-dimensional view of an open cell device comprising a substrate such as a current collector according to the invention assembled separator with a (Celgard 3501) impregnated with an ionic liquid EMITFSI 99.5% (Solvionic), so as to form a substrate/separator/substrate structure after pressing under 1 N by tightening the screws of the pressing plates with a torque screwdriver.

FIG. 8 shows Nyquist diagrams obtained with current collectors according to the invention comprising different SBR/C volume ratios (%), in particular current collectors having a SBR/C volume ratio of 153% (x), 191% (points marked by triangles), 298% (points marked by diamonds), 687% (points marked by squares), and a commercial current collector of the NPC-055D Korea JCC type supplied by the company Samwha ( [symbol] ), as well as details of these same diagrams.

FIG. 9 represents the Equivalent Series Resistance (ESR) evaluated from the Nyquist diagrams presented in FIG. 8, for different SBR/C volume ratios of different current collectors, in particular a commercial current collector of the NPC-055D Korea JCC type supplied by the company Samwha ( [symbol] ), current collectors according to the invention comprising between 0.15 mg of SBR per cm² and 0.43 mg of SBR per cm² as prepared in Example 3 (points marked by black disks), VACNT layers as prepared in Example 1 without polymeric coating (points marked by triangles), and current collectors according to the invention comprising more than 1 mg of SBR per cm² as prepared in Example 3 (points marked by squares).

FIG. 10 shows the results of visual evaluation tests of the mechanical strength of a commercial current collector of the NPC-055D Korea JCC type supplied by Samwha Company, of a supported VACNT layer as prepared in Example 1 without polymer coating, and that of current collectors according to the invention, for different SBR/C volume ratios.

### DESCRIPTION OF THE INVENTION

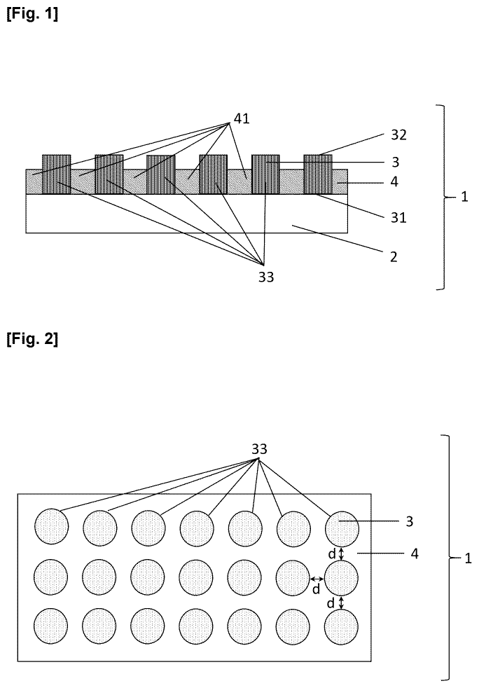

We describe here a current collector according to the invention, with reference to FIGS. 1, 2 and 3. The present invention describes a current collector (1) for an electrochemical system or device for storing or generating electrical energy comprising:
a. an electronically conductive substrate (2),
b. an electrically non-conductive polymer matrix (4), and
c. carbon nanotubes which are advantageously vertically aligned nanotubes (3), hereinafter VACNT from the English “Vertically Aligned Carbon Nano Tubes”, said nanotubes comprising
   a first end called a transfer end (31), making it possible to transfer the current to the substrate, this first end being fixed on the surface of said electronically conductive substrate, and electrically connected to the surface of said electronically conductive substrate,
   as well as a second end (32), opposite said first end, called a collection end, capable of collecting the current from an external active material (5), in particular from an electrode, so as to create on the surface of said electronically conductive substrate (2), a layer comprising a plurality of collection regions, which are electrically insulated from each other by intercalary zones of said electrically non-conductive polymer matrix, and wherein
      each collection region comprises a plurality of said carbon nanotubes, and
      all of the second ends of said carbon nanotubes of each collection region protrude beyond the surface of the electrically non-conductive polymer matrix.

The invention will be explained below mainly in relation to vertically aligned carbon nanotubes, which represent a particularly advantageous embodiment of the invention. This does not, however, limit the scope of the invention to vertically aligned nanotubes: for example, the nanotubes may be aligned other than vertically, while remaining parallel to each other (e.g., they may be tilted), or they may be unaligned relative to each other. Furthermore, the nanotubes may have been synthesized (i.e. deposited by a chemical process, typically in the vapor phase) on this electronically conductive substrate, or they may have been mechanically transferred onto said electronically conductive substrate, after having been synthesized on another substrate. A transfer of vertically aligned nanotubes from one substrate to another can be done with techniques known to those skilled in the art; an example will be given below.

The presence of vertically aligned carbon nanotubes (3) on the electronically conductive substrate (2), hereinafter referred to as vertically aligned carbon nanotube layer or VACNT carpet, provides numerous electrical contact points for the active material (5), thanks to their large specific surface area and vertical orientation. The synthesis of VACNTs on the electronically conductive substrate (2) makes it possible to ensure direct electrical contact between the electronically conductive substrate (2) and the active material (5) through the unit tubes of the VACNTs. This makes it possible to limit the quantity of conductive particles in the active material but also to significantly reduce the interfacial resistance between the active material (5) and the electronically conductive substrate (2).

The presence of an electrically non-conductive polymer matrix (4) improves the adhesion of VACNTs to the substrate. It offers purely polymeric attachment zones to the active material (5) of the electrode, freeing up the choice of binders ensuring the mechanical cohesion of the electrode. Using such an electrically non-conductive polymer matrix (4) makes it possible to significantly reduce the quantity of binder within the electrode. The electrically non-conductive polymer matrix (4) is preferably an electronically non-conductive material, and advantageously has good ionic conductivity.

The inventors noted that coating VACNTs directly synthesized on an electronically conductive substrate (2) with an electrically non-conductive polymer matrix (4) made it possible to generate bimodal porosity particularly suited to the intended application. Indeed, the synthesized VACNT carpet advantageously has a regular inter-tube spacing of less than 100 nm, preferably of the order of 5 nm to 50 nm depending on the synthesis conditions. The electrically non-conductive polymer matrix (4) is advantageously produced from any suitable electrically non-conductive polymer or mixture of suitable electrically non-conductive polymers, such as poly(styrene/butadiene) known by the acronym SBR (from the English Styrene-Butadiene Rubber), carboxymethylcellulose known by the acronym CMC or poly(acrylic acid) known by the acronym PAA.

The non-electrically conductive polymer matrix, in particular the polymer(s) constituting this polymer matrix, will be chosen according to the final use of the current collector according to the invention, of the energy storage device comprising it, in particular of the temperature resistance in operation targeted by the device, of the different materials constituting said device, such as the active material of the electrodes. Poly(styrene/butadiene) will be used in particular as a polymer matrix because it has good temperature resistance, good chemical and electrochemical compatibility with the active materials and binders used in battery electrodes, and it is inexpensive.

The deposition of the electrically non-conductive polymer matrix (4) on the electronically conductive substrate (2) previously coated with vertically aligned carbon nanotubes (3) surprisingly regardless of its deposition method, on the surface of said electronically conductive substrate (2), a layer comprising a plurality of collection regions (33), which are electrically isolated from each other by intermediate zones (41) of said electrically non-conductive polymer matrix, and where each collection region (33) comprises a plurality of said vertically aligned carbon nanotubes (3).

Advantageously, the vertically aligned carbon nanotubes of the collection regions (33) have an average inter-tube spacing of less than 100 nm in order to ensure sufficient direct electrical contact between the electronically conductive substrate (2) and the active material (5), in particular an electrode. Said collection regions (33) advantageously have a circular shape and the smallest distance (d) between the outer edges of said collection regions is greater than or equal to 1 μm, preferably greater than 10 μm, preferentially between 1 μm and 50 μm. This distance is of the order of the size of the particles of active materials usually used in the electrodes of electrochemical energy storage systems. This particular structure of the current collector according to the invention has both areas very suitable for the attachment of the active material (i.e. intermediate areas of the non-electrically conductive polymer matrix) and areas very suitable for electrical conduction (i.e. collection regions). The collection regions (33) and the intermediate zones (41) of the electrically non-conductive polymer matrix are distributed homogeneously on the surface of the current collector, not generating inhomogeneities in adhesion or electrical conduction, which could be detrimental to the operation of the energy storage device comprising such a current collector according to the invention.

The current collector according to the invention makes it possible, in an optimal manner, to effectively ensure the adhesion of the active material while limiting the interfacial resistance when:
the vertically aligned carbon nanotubes of the collection regions (33) have an average inter-tube spacing of less than 100 nm, and
said collection regions (33) have a circular shape, and where the smallest distance (d) between the outer edges of said collection regions is greater than or equal to 1 μm, preferably greater than 10 μm, preferentially between 1 μm and 50 μm.

The vertically aligned carbon nanotubes (3), electrically connected to the surface of said electronically conductive substrate (2), advantageously have a thickness of less than 10 μm, preferably less than 1 μm in order to minimize the additional mass linked to the use of these vertically aligned carbon nanotubes (3), i.e. to minimize the final weight of the current collector according to the invention, and ultimately to optimize the electrochemical energy storage system comprising such a current collector according to the invention.

The vertically aligned carbon nanotubes (3), electrically connected to the surface of said electronically conductive substrate (2), advantageously have a developed surface area greater than 100 m²/g, preferably greater than 250 m²/g in order to maximize the contact between the external active material (5), in particular of an electrode and the carbon nanotubes, preferably the so-called collection ends (32) of the carbon nanotubes.

The volume ratio of non-electrically conductive polymer matrix/carbon nanotubes of the current collector according to the invention, hereinafter also called polymer matrix/C volume ratio, is advantageously less than 300%, preferably less than 200%, and even more preferably less than 70%. This volume ratio is determined as a function of the quantity of carbon nanotubes and that of the polymer(s) constituting the electrically non-conductive polymer matrix present within the current collector according to the invention, and their respective theoretical densities. A polymer matrix/C volume ratio of less than 300%, preferably less than 200%, and even more preferably less than 70%, advantageously makes it possible to effectively ensure the adhesion of the active material while limiting the interfacial resistance existing between the electronically conductive substrate and the active material of the electrode, regardless of the chemical nature of the electrically non-conductive polymer matrix.

The polymer matrix/C volume ratio is advantageously chosen according to the final application of the energy storage device comprising t collector according to the invention.

The shape of the electronically conductive substrate is advantageously adapted to the architecture of the energy storage device comprising it. The electronically conductive substrate can thus be chosen from flat substrates, grid-shaped substrates, fiber-shaped substrates and felt-shaped substrates. The nature chemical of the electronically conductive substrate is chosen in particular according to the operating conditions of the energy storage device comprising it and the processes used during the manufacture of this energy storage device. The electronically conductive substrate may be a metal, a metal alloy or even composite materials comprising carbon, hereinafter called carbon materials. It is preferably chosen from copper, aluminum, nickel, stainless steel, heavily doped silicon, carbon and composite materials comprising carbon and, preferably, composite materials comprising carbon and a resin chosen from polyester, vinyl ester, epoxy, phenolic, polyimide, polyamide, polypropylene, polyetheretherketone resins or a mixture of one or more of these.

We now describe the production of vertically aligned carbon nanotubes in the form of carpets.

Vertically aligned carbon nanotubes, in the form of carpets, virtually free of by-products and exhibiting controlled physicochemical characteristics (length, diameter, density of carbon nanotubes), can be produced on an electronically conductive substrate, by any means, and are advantageously synthesized by chemical vapor deposition (CVD) process.

Vertically aligned carbon nanotube carpets or layers can be made by this process in one or two steps on the surface of the electronically conductive substrate. Carbon nanotubes, obtained by either of these processes, advantageously have a diameter between 5 nm and 50 nm, which ensures a good compromise between the developed surface (which must be large to improve electrical contact) and the intrinsic electrical conductivity of the nanotubes.

The one-step chemical vapor deposition process from aerosols, preferably from a solution of ferrocene in toluene, makes it possible to synthesize, on substrates of different natures, vertically aligned carbon nanotubes having physicochemical characteristics that can be modulated according to the intended application, in particular by controlling the diameter, length and density of the carbon nanotubes, and this over a wide range. In this one-step process, the carbon precursors and catalyst precursors are injected simultaneously into the reactor, at a temperature between 550 °C and 850 °C, so as to induce the nucleation and growth of carbon nanotubes. The synthesis temperature is advantageously around 800 °C. This is a low-cost and easily industrializable process. This process makes it possible to obtain carbon nanotubes having a diameter advantageously between 20 nm and 40 nm for a density of 109 carbon nanotubes/cm² and more generally a diameter between 5 nm and 50 nm for a density between 108 and 1012 nanotubes/cm².

The two-step chemical vapor deposition process involves the deposition of a layer of a catalyst material made prior to the nucleation and growth step of carbon nanotubes from a gaseous carbon source, such s acetylene. The use of acetylene allows the synthesis temperature to be lowered to below 650 °C. This offers the possibility of growing carbon nanotubes on substrates with a lower melting temperature such as aluminium. This process advantageously makes it possible to obtain carbon nanotubes with a diameter of less than 5 nm, denser than those obtained by the one-step process (density greater than or equal to 1011 carbon nanotubes/nm²).

Furthermore, the growth rate and thickness of the carbon nanotube film can be adjusted by controlling the reaction temperature, or by adjusting the acetylene concentration in the reactor. Adjustment of the catalyst particle size, catalyst material employed, reactants and/or additive species, temperature, pressure and other parameters, by methods known to those skilled in the art, allows for appropriate control of the morphology and density of the vertically aligned carbon nanotubes in these VACNT layers or carpets.

The electronically conductive substrate, as previously indicated, can be heavily doped silicon, a metal or metal alloy, carbonaceous materials. For growth on metals or carbon substrates, the deposition of a barrier sublayer, preferably SiOₓ, prior to the growth of carbon nanotubes by chemical vapor deposition is sometimes necessary to avoid the diffusion of carbon into the substrate, or to promote the reactivity of the catalyst. For one-step processes, this deposition precedes the feeding of the reactor with catalyst and carbon precursors necessary for the growth of carbon nanotubes. For two-step processes this deposition precedes the deposition of the catalyst. A deposit on an aluminum substrate does not require depositing a barrier sublayer because the native oxide already acts as a barrier sublayer.

The production of a current collector according to the invention is now described.

On the supported vertically aligned carbon nanotube carpets or layers, a non-electrically conductive polymer matrix is deposited by any suitable means, preferably by a liquid phase deposition process, so as to obtain a current collector according to the invention. The deposition of this polymeric matrix makes it possible to create on the surface of the electronically conductive substrate, a layer comprising a plurality of collection regions, which are electrically isolated from each other by intermediate zones of said electrically non-conductive polymeric matrix, and where
each collection region comprises a plurality of said vertically aligned carbon nanotubes, and
all of the second ends of said vertically aligned carbon nanotubes of each collection region protrude beyond the surface of the electrically non-conductive polymeric matrix.

Advantageously, the deposition of said electrically non-conductive polymer matrix is carried out by any suitable means, preferably by a method chosen from coating, spraying, soak-removal of a liquid phase in which the polymer(s) are dissolved in a suitable solvent. This solvent is then removed, in particular by evaporation. The deposition of the polymer matrix can also be carried out by extrusion, infiltration in one or more stages or by infusion in one or more stages. After deposition of the polymer matrix, the current collector according to the invention can also undergo a hot pressing or lamination step, in order to consolidate its mechanical structure.

These deposit methods are simple and quick to implement. The method used to deposit said polymer matrix will be chosen in particular according to the chemical nature of the polymer matrix used.

### EXAMPLES

The invention is illustrated below by examples which, however, do not limit the invention. These examples relate to the preparation of current collectors according to the invention and their evaluation with respect to a commercial current collector. The commercial current collector, used for comparison, is a sheet referenced NPC-055D Korea JCC supplied by the Samwha company. The commercial current collector is consisting of a 50 μm thick aluminum sheet, coated on its two opposite faces with a carbon coating with a thickness of between 1 μm and 2 μm, and comprising carbon black particles having an average diameter of 160 μm integrated in a polymeric binder.

### Example 1: Production of VACNT Carpets in a Single Step Using Chemical Vapor Deposition

Vertically aligned carbon nanotubes were synthesized on an aluminum substrate by chemical vapor deposition (CVD) from ferrocene dissolved in toluene, hydrogen and acetylene.

To do this, a 20 μm thick aluminum substrate is continuously supplied into a roll-to-roll reactor. The reaction chamber is supplied with argon, acetylene, hydrogen, ferrocene and toluene vapors. The substrate temperature in the reaction chamber is 615 °C. The pressure in the reaction chamber is atmospheric pressure (plus or minus 15 Pa). The scroll speed of the aluminum substrate is adjusted so that the passage time of the substrate in the reaction chamber is equal to 2 min. At the outlet of the roll-to-roll reactor, the substrate is covered with a layer of VACNT with a thickness equal to 2 μm.

### Example 2: Production of VACNT Carpets in Two Steps Using Chemical Vapor Deposition

A 6-inch silicon wafer (p-type, 1-10 Ω·cm, Silicon Quest International) was supplied and then cleaned using a standard “piranha” solution consisting of one part hydrogen peroxide to three parts sulfuric acid. A 1/10 nm Fe/Al₂O₃ patterned catalyst film was then deposited on this cleaned silicon wafer by electron beam evaporation in a single pump cycle using a Temescal VES-2550 coupled with an FDC-8000 film deposition controller. The catalyst pattern was fabricated by lift-off of a 1 μm thick image-reversing photoresist layer (AZ-5214E), which was itself patterned by photolithography. The catalyst was deposited over the entire surface of the silicon wafer. The areas where the catalyst was deposited on the photoresist were then removed by soaking in an acetone bath for 5 minutes, with gentle sonication. The thickness of the catalyst film was measured during deposition using a quartz crystal monitor and was subsequently confirmed by Rutherford backscattering spectrometry (RBS).

The silicon wafer coated with the Fe/Al₂O₃ patterned film was introduced into a single-zone atmospheric pressure quartz tubular furnace (Lindberg), having an inner diameter of 22 mm on the 30 cm long heating plate. The furnace was then brought to the setpoint temperature of 700 °C in 30 minutes and then maintained for an additional 15 minutes under 400 cm³ standard/minute flow of argon. A mixture of argon (Ar, 99.999%, Airgas), ethylene (C₂H₄, 99.5%, Airgas) and hydrogen (H₂, 99.999%, BOC) under a flow of 100/500/200 cm³ standard/minute of C₂H₄/H₂/Ar was then introduced into the tube furnace, in order to induce the growth of carbon nanotubes. This flow was maintained for 1 minute to allow the growth of carbon nanotubes.

The H₂ and C₂H₄ flows were then interrupted and a flow of 400 cm³ standard/min of Argon was maintained for a further 10 minutes to displace the gaseous reactants from the tube furnace, before being reduced to a slight flow while the furnace cooled to below 100 °C.

A layer of carbon nanotubes mainly oriented perpendicular to the substrate, i.e. a VACNT layer, of approximately 5 μm thickness was obtained.

### Example 3: Preparation of a Current Collector According to the Invention

The previously obtained supported VACNT layers as prepared in Example 1 and Example 2 were coated with a copolymer of butadiene and styrene (known by the acronym SBR, from the English Styrene-Butadiene Rubber) by dip coating. To do this, a toluene solution comprising 20 mg of SBR per mL was prepared. The previously obtained VACNT layers were dipped into this solution with a dipping speed of 10 mm/s and then remained immersed in this solution for 10 seconds before being removed at a speed of 10 mm/s.

In order to evaluate the influence of the polymer matrix/C volume ratio, abbreviated hereinafter in the examples as SBR/C volume ratio, current collectors according to the invention were prepared by carrying out several dipping-immersion-withdrawal cycles, as indicated above, in the toluene solution comprising 20 mg of SBR per mL.

In order to prepare a current collector according to the invention comprising 4.5 mg of SBR per cm², a toluene solution comprising 100 mg of SBR per mL was prepared, then was pipetted onto a supported VACNT layer as prepared in Example 1.

Current collectors according to the invention made from supported VACNT layers as synthesized in example 1 and comprising between 0.15 mg of SBR per cm² and 4.5 mg of SBR per cm² were thus obtained. The properties of these current collectors were compared particular by impedance spectroscopy, to those of supported VACNT layers as developed in example 1 without polymeric coating, to those of aluminum substrate and to those of the commercial current collector NPC-055D Korea JCC supplied by the company Samwha.

### Example 4: Evaluation of Current Collectors According to the Invention

### 4.1: In Swagelok™ Type Supercapacitor Cells Comprising Wet Activated Carbon Electrodes

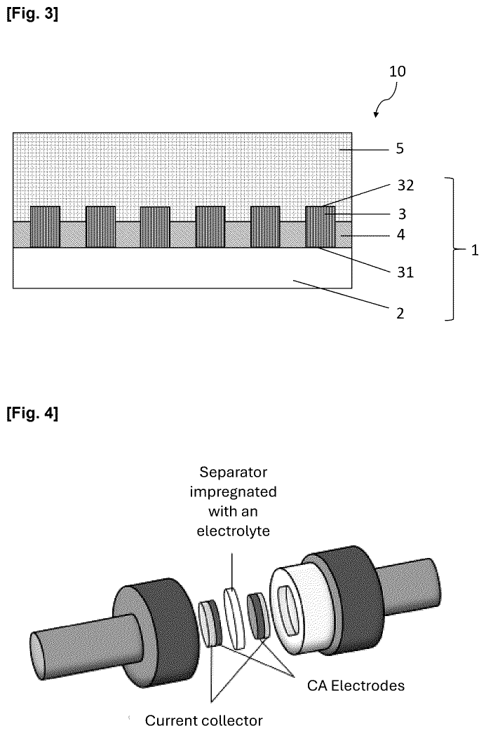

In a mortar, 85% by mass of activated carbon (i.e. activated carbon (hereinafter CA) serving as active material), 10% by mass of polyvinylidene fluoride used as binder (Kynar 3103) and 5% by mass of carbon black (Timcal™) were mixed in N-Methyl-2-pyrrolidone abbreviated NMP. The hereinafter viscous solution obtained was then deposited by doctor blade coating at a thickness of 200 μm, on a current collector according to the invention as prepared in Example 3 comprising on average 0.23 mg SBR/cm², and for comparison, on an aluminum substrate, and on the commercial current collector. After drying in an oven, current collector discs+electrode were cut and assembled, in a glove box, with a separator (Celgard Epp 1208) impregnated with an ACN NEt4BF4 1M (ABCR) electrolyte as shown in FIG. 4, so as to form a Swagelok™ type supercapacitor cell.

Impedance spectroscopy measurements were performed in potentiostatic mode, with a constant voltage set at 0.02 V and a frequency sweep between 400 kHz and 100 mHz. The Equivalent Series Resistance (commonly abbreviated as ESR) was evaluated from the impedance spectroscopy measurements and is presented below in Table 1.

TABLE 1

| | Equivalent |
|---|---|
| | series |
| | resistance |
| Current collector used | [Ω · cm²] |
| Aluminium substrate | 0.37 |
| Current collector according to | 0.80 |
| the invention comprising on | |
| average 0.23 mg de SBR par cm² | |
| Collecteur de courant commercial | 1.29 |
| NPC-055D Korea JCC (Samwha) | |

### 4.2: In Swagelok™ Type Supercapacitor Cells Comprising Self-Supporting Electrodes

95% by mass of reference CA YP80F (Kuraray), 5% by mass of an aqueous solution comprising 60% polytetrafluoroethylene (PTFE) (Sigma Aldrich) were mixed in ethanol, under magnetic stirring and heating. The resulting paste was then flattened to a thickness of approximately 150 μm, then discs were cut from the films obtained and dried in an oven. The self-supported electrodes, also called “dry” electrodes in English, thus obtained were then assembled, in a glove box, with a substrate serving as a current collector, a separator (Celgard Epp 1208) impregnated with an ACN NEt4BF4 1 M (ABCR) electrolyte as shown in FIG. 5, so as to form a Swagelok™ type supercapacitor cell.

For comparison, the Swagelok™ type supercapacitor cell was produced with different substrates serving as current collectors, namely an aluminum substrate, a current collector according to the invention as developed in example 3 comprising on average 0.23 mg SBR/cm², and the aforementioned commercial current collector. The Equivalent Series Resistance (ESR) was evaluated from the measurements carried out by impedance spectroscopy and presented below in Table 2.

TABLE 2

| | Equivalent |
|---|---|
| | series |
| | resistance |
| Current collector used | [Ω · cm²] |
| Aluminium substrate | 0.61 |
| Current collector according to the | 0.85 |
| invention, comprising on average 0.23 | |
| mg SBR per cm² | |
| Commercial current collector NPC-055D | 1.35 |
| Korea JCC (Samwha) | |

### 4.3: In a Half-Cell of a Battery Cell of the Type “Coin Cells 2032”

production of a LifePO₄ cathode layer on a substrate that can serve as a current collector

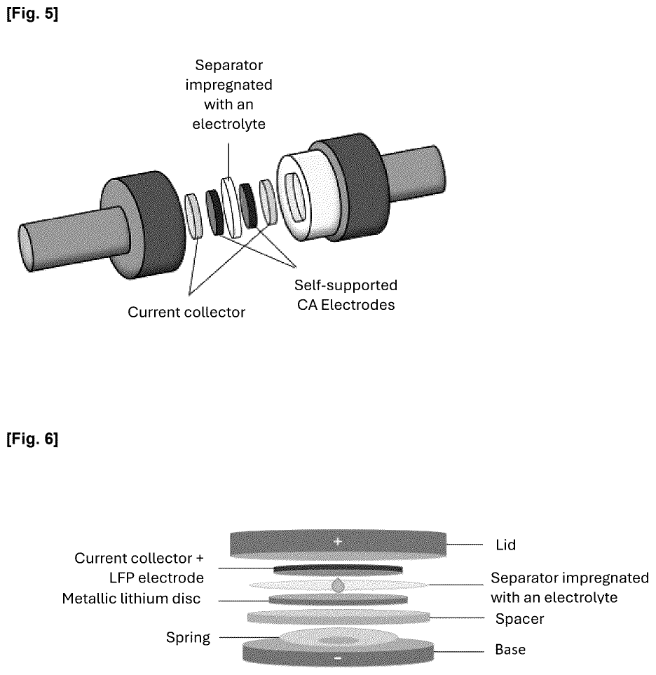

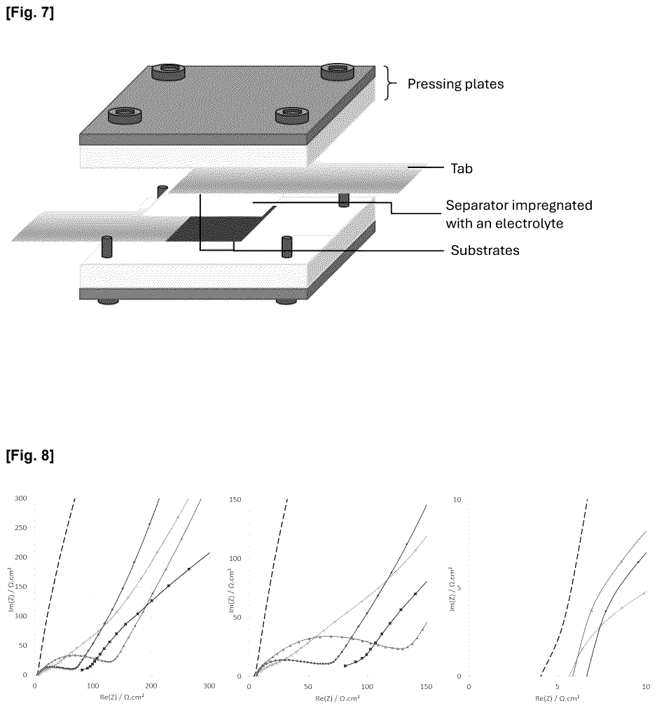

In a mortar, 75% by mass of LifePO₄ hereinafter LFP (Sigma Aldrich), 5% by mass of polyvinylidene fluoride (PVdF) used as binder (Kynar 1810) and 20% by mass of carbon black (Norit) were mixed in N-Methyl-2-pyrrolidone, known by the acronym NMP. The viscous solution obtained was then deposited by doctor blade coating at a thickness of 100 μm, on a current collector according to the invention as prepared in Example 3 comprising on average 0.23 mg SBR/cm², and for comparison, on an aluminum substrate in order to obtain a cathode layer. After drying in an oven, current collector+electrode discs were cut out and then assembled, in a glove box, with a separator (Celgard 3501) impregnated with a 1M LiPF₆ electrolytic solution in a mixture of ethyl carbonate (hereinafter EC) and diethyl carbonate (hereinafter DEC) with an EC/DEC ratio (1:1) (Sigma Aldrich), and a lithium metal disc, as shown in FIG. 6, so as to form a half-battery cell.

Impedance spectroscopy measurements were performed in potentiostatic mode, with a constant voltage set to OV and a frequency sweep between 10 kHz and 100 mHz. The Equivalent Series Resistance (ESR) was evaluated from the impedance spectroscopy measurements and presented below in Table 3.

TABLE 3

| | Equivalent series |
|---|---|
| | resistance |
| Current collector used | (Ω · cm²) |
| Aluminium substrate | 110 |
| Current collector according to the | 23 |
| invention comprising on average | |
| 0.23 mg of SBR per cm² | |

production of a cathode layer in LiNi_{0.8}Mn_{0.1}Co_{0.1}O₂ on a substrate that can serve as a current collector

A coating of LiNi_{0.8}&Mn_{0.1}Co_{0.1}O₂ hereinafter NMC811 was made on a substrate which can serve as a current collector. In a mortar, 222.5 g of NMC811, 3.18 g of polyvinylidene fluoride (PVdF) used as binder and 1.36 g of carbon black were mixed in 74.1 g of N-Methyl-2-pyrrolidone (NMP). The solution obtained has a solid fraction of 75.1% and a viscosity of 2910 mPa at 25 °C. This viscous solution was then deposited by doctor blade coating at a thickness of 100 μm, on a current collector according to the invention as developed in Example 3 comprising on average 0.23 mg SBR/cm², and for comparison, on an aluminum substrate in order to obtain a cathode layer. After drying in an oven, allowing the NMP to be eliminated, current collector discs+electrode were cut out and then assembled, in a glove box, with a separator (Celgard 3501) impregnated with 40 μL of a 1M LiPF₆ electrolytic solution in a mixture of ethyl carbonate (hereinafter EC) and diethyl carbonate (hereinafter DEC) with an EC/DEC ratio (1:1) (Sigma Aldrich), and a metallic lithium disk, as shown in FIG. 6, so as to form a half battery cell.

The electrodes produced comprise 98% by mass of NMC811 as active material, 0.6% by mass of conductive carbon and 1.4% by mass of PVdF.

The electrodes produced were characterized by power pulse test and by ohmic drop measurement under the same operating conditions.

### 4.4: Evaluation of the Current Collector According to the Invention by Impedance Spectroscopy

Current collectors according to the invention comprising between 0.15 mg of SBR per cm² and 4.5 mg of SBR per cm² as prepared in Example 3, VACNT layers as prepared in Example 1 without polymer coating, an aluminum substrate and the commercial current collector NPC-055D Korea JCC (Samwha), were evaluated by impedance spectroscopy.

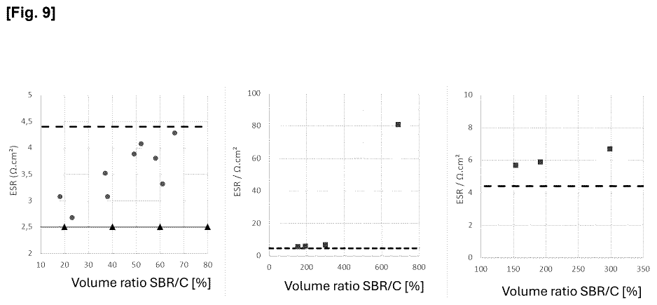

To do this, each of these substrates was introduced into an “open” cell device as shown in FIG. 7 and assembled with a separator (Celgard 3501) impregnated with an ionic liquid EMITFSI 99.5% (Solvionic) as electrolyte, so as to form a substrate/separator/substrate structure.

Impedance spectroscopy measurements were performed in potentiostatic mode, with a constant voltage set at 0.02 V and a frequency sweep between 400 kHz and 100 mHz.

The Nyquist diagrams obtained with these different substrates are presented in FIG. 8; they allow the evaluation of the Equivalent Series Resistance (ESR) as well as the additional parallel resistance linked to the diffusion of ions as indicated in the publication by D. Larcher et al., “Energy storage in the world of transport”, Chemistry and transport, EDP Science (2014) Chapter 13. The Equivalent Series Resistance (ESR) was evaluated from the measurements carried out by impedance spectroscopy and presented below in Table 4 and represented below in FIG. 9 as a function of the SBR/C volume ratio of the current collectors according to the invention, with respect to the commercial current collector NPC-055D Korea JCC (Samwha).

TABLE 4

| | Commercial | | | | | | | | |
|---|---|---|---|---|---|---|---|---|---|
| | current | | | | | | | | |
| | collector | | | | | | | | |
| | NPC-055D | Current collectors according to the | | | | | | | |
| Substrat | Korea JCC | invention comprising a VACNT layer | | | | | | | |
| studied | (Samwha) | supported and coated by SBR | | | | | | | |
| Mass of SBR | — | 0 | 0.15 | 0.32 | 0.43 | 1 | 1.25 | 1.95 | 4.5 |
| [mg/cm²] | | | | | | | | | |
| Volume | — | 0 | 23 | 49 | 66 | 153 | 191 | 298 | 687 |
| ratio | | | | | | | | | |
| SBR/carbon | | | | | | | | | |
| [%] | | | | | | | | | |
| Equivalent | 4.4 | 2.5 | 2.7 | 3.9 | 4.3 | 5.7 | 5.9 | 6.7 | 81.0 |
| series | | | | | | | | | |
| resistance | | | | | | | | | |
| [Ω · cm²] | | | | | | | | | |

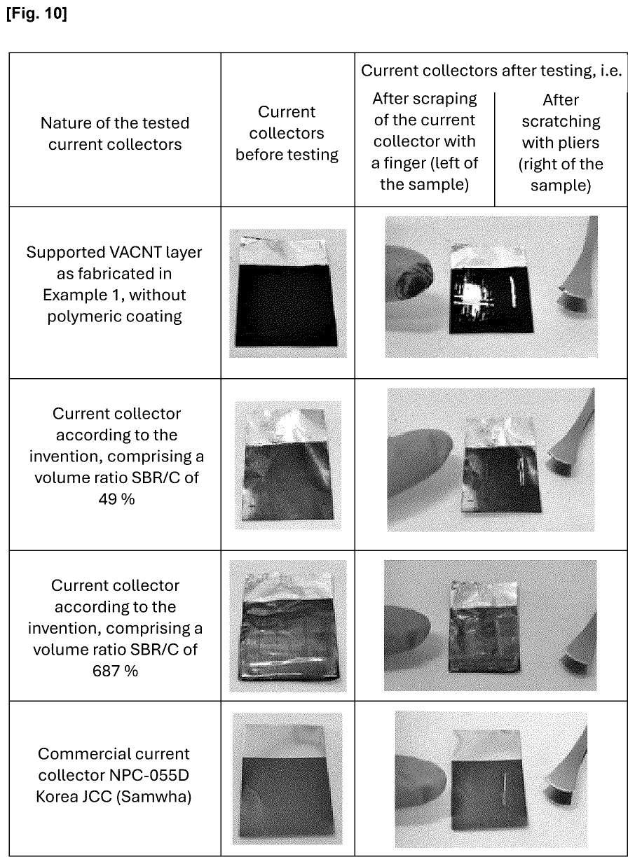

The mechanical resistance of the different current collectors according to the invention was evaluated visually, as illustrated in FIG. 10, by finger scraping (left of the samples) and scratching with pliers (right of the samples). The current collectors according to the invention, in particular comprising a volume ratio of SBR/C of 49% and 687%, have better mechanical resistance than a supported VACNT layer as prepared in Example 1 or than a commercial current collector NPC-055D Korea JCC (Samwha).

The properties of the current collectors according to the invention are summarized in Table 5 below.

TABLE 5

| | Equivalent |
|---|---|
| | series |
| | resistance ESR |
| Substrat studied | [Ω · cm²] |
| VACNT layers as elaborated in Example 1 | 2.5 |
| without polymer coating | |
| Current collectors according to the | 2.7 < ESR < 4.3 |
| invention comprising between 0.15 mg of | |
| SBR per cm² and 0.43 mg of SBR per cm² | |
| as elaborated in Example 3 | |
| Commercial current collector NPC-055D | 4.4 |
| Korea JCC (Samwha) | |
| Current collectors according to the | >5.7 |
| invention comprising on average more | |
| than 1 mg of SBR per cm² such as those | |
| obtained in example 3 | |

### Example 5: Transfer of Vertically Aligned Nanotubes from their Growth Substrate to Another Substrate

A sample of vertically aligned nanotubes (in the form of a carpet with a thickness of about 30 μm) was made according to Example 1, on a stainless steel substrate instead of an aluminum substrate. The sample was then mechanically compressed against a copper current collector (12 μm thick) without surface coating, using a laboratory calender with stainless steel rollers (TOB-JS-300), with a gap of 30 μm and a maximum pressure of 500 N/mm.

1. A current collector for an electrical energy storage system or electrical generation system, comprising:
an electronically conductive substrate;
an electrically non-conductive polymer matrix; and
carbon nanotubes, the carbon nanotubes comprising:
a first end making it possible to transfer the current to the electronically conductive substrate, the first end being fixed on the surface of the electronically conductive substrate and electrically connected to the latter; and
a second end, opposite the first end, capable of collecting the current from an external active material,
so as to create on the surface of the electronically conductive substrate, a layer comprising a plurality of collection regions, which are electrically insulated from each other by intercalary zones of the electrically non-conductive polymer matrix,
wherein each collection region comprises a plurality of the carbon nanotubes, and all of the second ends of the carbon nanotubes of each collection region protrude beyond the surface of the electrically non-conductive polymer matrix.

2. The current collector according to claim 1, wherein the carbon nanotubes are aligned.

3. The current collector according to claim 14, wherein, in a top view,
the vertically aligned carbon nanotubes of the collection regions have an average intertube spacing of less than 100 nm, and/or
the collection regions have a circular shape and the smallest distance between the outer edges of the collection regions is greater than or equal to 1 μm.

4. The current collector according to claim 1, wherein the electronically conductive substrate is copper, aluminum, nickel, stainless steel, heavily doped silicon, carbon, or a composite material comprising carbon.

5. The current collector according to claim 1, wherein the electronically conductive substrate is a flat substrate, a substrate in the form of a grid, a substrate in the form of fibers, or a substrate in the form of felt.

6. The current collector according to claim 14, wherein the vertically aligned carbon nanotubes, electrically connected to the surface of the electronically conductive substrate, have;
a thickness of less than 10 μm, and/or
a developed surface area of greater than 100 m²/g.

7. The current collector according to claim 1, wherein the volume ratio of non-electrically conductive polymer matrix/carbon nanotubes is less than 300%.

8. A device or system for storing or generating electrical energy, wherein the device or system comprises the current collector according to claim 1.

9. A method of manufacturing a current collector comprising an electronically conductive substrate, carbon nanotubes having one end fixed to the surface of the electronically conductive substrate, and an electrically non-conductive polymer matrix, the method comprising the following successive steps:
(a) synthesizing, on the electronically conductive substrate, vertically aligned carbon nanotubes so as to form a carpet or transferring aligned nanotubes synthesized on another substrate onto the electronically conductive substrate; and
(b) depositing the electrically non-conductive polymer matrix on the carbon nanotubes, so as to create on the surface of the electronically conductive substrate, a layer comprising a plurality of collection regions, which are electrically insulated from each other by intercalary zones of the electrically non-conductive polymer matrix,
wherein each collection region comprises a plurality of the carbon nanotubes, and
wherein all of the second ends of the carbon nanotubes of each collection region protrude beyond the surface of the electrically non-conductive polymer matrix.

10. The method of manufacturing the current collector comprising the electronically conductive substrate, the carbon nanotubes having one end fixed on the surface of the electronically conductive substrate, and the electrically non-conductive polymer matrix, according to claim 9, wherein the deposition of the electrically non-conductive polymer matrix, during step (b), is carried out by coating, spraying, soak-removal, extrusion, or infiltration in one or more steps.

11. The current collector according to claim 1, wherein the first end is a transfer end and the second end is a collector end.

12. The current collector according to claim 1, wherein the external active material is an electrode.

13. The current collector according to claim 2, wherein the carbon nanotubes are substantially perpendicularly aligned relative to the electronically conductive substrate.

14. The current collector according to claim 13, wherein the carbon nanotubes substantially perpendicularly aligned relative to the electronically conductive substrate are vertically aligned carbon nanotubes.

15. The current collector according to claim 3, wherein the smallest distance between the outer edges of the collection regions is greater than 10 μm.

16. The current collector according to claim 1, wherein the electronically conductive substrate is a composite material comprising carbon and a resin including polyester, vinyl ester, epoxy, phenolic, polyimide, polyamide, polypropylene, polyetheretherketone resin, or a mixture of one or more of these.

17. The current collector according to claim 14, wherein the vertically aligned carbon nanotubes, electrically connected to the surface of the electronically conductive substrate, have:
a thickness of less than 1 μm, and/or
a developed surface area of greater than 250 m²/g.

18. The current collector according to claim 1, wherein the volume ratio of non-electrically conductive polymer matrix/carbon nanotubes is less than 200% or less than 70%.

19. The device or system according to claim 8, wherein the device or system is a battery, a supercapacitor, or a fuel cell.

20. The method of manufacturing the current collector according to claim 9, wherein synthesizing, on the electronically conductive substrate, the vertically aligned carbon nanotubes includes synthesizing, on the electronically conductive substrate, the vertically aligned carbon nanotubes by chemical vapor deposition, and
wherein depositing the electrically non-conductive polymer matrix on the carbon nanotubes includes depositing, by a liquid phase deposition process, the electrically non-conductive polymer matrix on the carbon nanotubes.
